(19) United States
(12) Patent Application Publication
(10) Pub. No.: US 2022/0269437 A1
(43) Pub. Date: Aug. 25, 2022

(54) Data Storage Device and Method for Predetermined Transformations for Faster Retrieval

(71) Applicant: Western Digital Technologies, Inc., San Jose, CA (US)

(72) Inventor: Ramanathan Muthiah, Bangalore (IN)

(73) Assignee: Western Digital Technologies, Inc., San Jose, CA (US)

(21) Appl. No.: 17/179,911

(22) Filed: Feb. 19, 2021

(51) Int. Cl. G06F 3/06; G06N 20/00

(52) U.S. Cl. CPC G06F 3/0659; G06F 3/0629; G06F 3/0611; G06F 3/0619; G06F 3/0673; G06N 20/00

(57) ABSTRACT

A data storage device and method for predetermined transformations for faster retrieval are provided. In one embodiment, a data storage device is provided comprising a memory and a controller. The controller is configured to: receive a write command from a host to write data in the memory, wherein the write command comprises an instruction to perform a data transformation operation on the data; and execute the write command by: performing the data transformation operation on the data to generate transformed data; and writing the transformed data in the memory. Other embodiments are provided.

### BACKGROUND

A host can store data in a data storage device and later retrieve the data. In some situations, after the host retrieves the data from the data storage device, the host performs a data transformation operation on the data. Some data storage devices have a compute-in-place feature that allows the host to offload the data transformation operation to the data storage device. In such environments, the host can send a read request to the data storage device that instructs the data storage device to read the data, perform a data transformation operation on the read data, and then return the result.

### BRIEF DESCRIPTION OF THE DRAWINGS

FIG. 1A is a block diagram of a data storage device of an embodiment.

FIG. 1B is a block diagram illustrating a storage module of an embodiment.

FIG. 1C is a block diagram illustrating a hierarchical storage system of an embodiment.

FIG. 2A is a block diagram illustrating components of the controller of the data storage device illustrated in FIG. 1A according to an embodiment.

FIG. 2B is a block diagram illustrating components of the memory data storage device illustrated in FIG. 1A according to an embodiment.

FIG. 3 is a block diagram of a host and data storage device of an embodiment.

FIG. 4 is a flow chart of a method of an embodiment for host-assisted pre-transformation performed in a write path.

FIG. 5 is a flow chart of a method of an embodiment for host-assisted pre-transformation performed in a read path.

FIG. 6 is a flow chart of a method of an embodiment for data-storage-device-assisted pre-transformation performed in a write path.

FIG. 7 is a flow chart of a method of an embodiment for data-storage-device-assisted pre-transformation performed in a read path.

### DETAILED DESCRIPTION

Overview

By way of introduction, the below embodiments relate to a data storage device and method for predetermined transformations for faster retrieval. In one embodiment, a data storage device is provided comprising a memory and a controller. The controller is configured to: receive a write command from a host to write data in the memory, wherein the write command comprises an instruction to perform a data transformation operation on the data; and execute the write command by: performing the data transformation operation on the data to generate transformed data; and writing the transformed data in the memory.

In some embodiments, the controller is further configured to write the data in the memory.

In some embodiments, the data and the transformed data are written to different logical regions of the memory.

In some embodiments, the different logical regions are both accessible by the host.

In some embodiments, the data and the transformed data are both written to the memory as part of executing the write command.

In some embodiments, the controller is further configured to: receive a read command from the host; determine whether the read command is requesting the data or the transformed data; in response to determining that the read command is requesting the data, return the data to the host; and in response to determining that the read command is requesting the transformed data, return the transformed data to the host.

In some embodiments, the controller is further configured to access, from the memory, information needed to perform the data transformation operation.

In some embodiments, the data transformation operation comprises one or more of the following: an operation that transforms the data between time and frequency domains, an operation that transforms the data between fixed-point and floating-point formats, a data approximation operation, an image analysis operation, a data filtering operation, a data reformatting operation, an operation that pre-processes the data for a machine learning algorithm, a convolution operation, and a lossless data transformation operation.

In some embodiments, the memory comprises a three-dimensional memory.

In another embodiment, a method is provided that is performed in a data storage device comprising a memory. The method comprises: receiving a write command from a host to write data in the memory; and executing the write command by: determining whether a data transformation operation should be performed on the data prior to writing the data in the memory; and in response to determining that the data transformation operation should be performed on the data prior to writing the data in the memory: performing the data transformation operation on the data to generate transformed data; and writing the transformed data in the memory.

In some embodiments, the determining is performed using machine learning.

In some embodiments, the method further comprises writing the data to the memory.

In some embodiments, the data and the transformed data are both written to the memory as part of executing the write command.

In some embodiments, the transformed data and the data are written in different logical unit numbers or namespaces.

In some embodiments, the different logical unit numbers or namespaces are both accessible by the host.

In some embodiments, the method further comprises: receiving a command from the host to perform a data transformation operation on first data that the host previously sent to the data storage device for storage; determining whether the data storage device already perform the data transformation operation on the first data; and in response to determining that the data storage device already performed the data transformation operation on the first data, returning a result of the already-performed data transformation operation on the first data to the host.

In some embodiments, the method further comprises: in response to determining that the data storage device did not already perform the data transformation operation on the first data, performing the data transformation operation on the first data and returning a result of the data transformation operation on the first data to the host.

In some embodiments, the method further comprises: accessing, from the memory, information needed to perform the data transformation operation.

In some embodiments, the data transformation operation comprises one or more of the following: an operation that transforms the data between time and frequency domains, an operation that transforms the data between fixed-point and floating-point formats, a data approximation operation, an image analysis operation, a data filtering operation, a data reformatting operation, an operation that pre-processes the data for a machine learning algorithm, a convolution operation, and a lossless data transformation operation.

In another embodiment, a data storage device is provided comprising a memory; means for receiving a command to perform a data transformation operation on data stored in the memory, wherein the command is received prior to receiving a command from the host to read the data; and means for performing the data transformation operation on the data.

Other embodiments are possible, and each of the embodiments can be used alone or together in combination. Accordingly, various embodiments will now be described with reference to the attached drawings.

### Embodiments

The following embodiments relate to a data storage device (DSD). As used herein, a “data storage device” refers to a device that stores data. Examples of DSDs include, but are not limited to, hard disk drives (HDDs), solid state drives (SSDs), tape drives, hybrid drives, etc. Details of example DSDs are provided below.

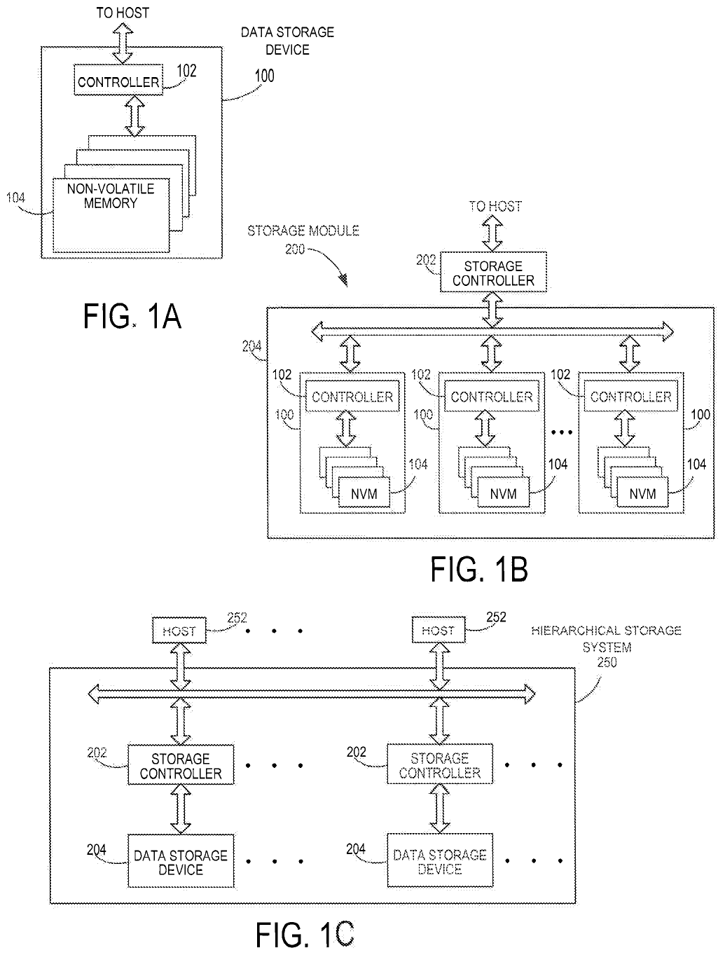

Data storage devices suitable for use in implementing aspects of these embodiments are shown in FIGS. 1A-1C. FIG. 1A is a block diagram illustrating a data storage device 100 according to an embodiment of the subject matter described herein. Referring to FIG. 1A, data storage device 100 includes a controller 102 and non-volatile memory that may be made up of one or more non-volatile memory die 104. As used herein, the term die refers to the collection of non-volatile memory cells, and associated circuitry for managing the physical operation of those non-volatile memory cells, that are formed on a single semiconductor substrate. Controller 102 interfaces with a host system and transmits command sequences for read, program, and erase operations to non-volatile memory die 104.

The controller 102 (which may be a non-volatile memory controller (e.g., a flash, resistive random-access memory (ReRAM), phase-change memory (PCM), or magnetoresistive random-access memory (MRAM) controller)) can take the form of processing circuitry, a microprocessor or processor, and a computer-readable medium that stores computer-readable program code (e.g., firmware) executable by the (micro)processor, logic gates, switches, an application specific integrated circuit (ASIC), a programmable logic controller, and an embedded microcontroller, for example. The controller 102 can be configured with hardware and/or firmware to perform the various functions described below and shown in the flow diagrams. Also, some of the components shown as being internal to the controller can also be stored external to the controller, and other components can be used. Additionally, the phrase “operatively in communication with” could mean directly in communication with or indirectly (wired or wireless) in communication with through one or more components, which may or may not be shown or described herein.

As used herein, a non-volatile memory controller is a device that manages data stored on non-volatile memory and communicates with a host, such as a computer or electronic device. A non-volatile memory controller can have various functionality in addition to the specific functionality described herein. For example, the non-volatile memory controller can format the non-volatile memory to ensure the memory is operating properly, map out bad non-volatile memory cells, and allocate spare cells to be substituted for future failed cells. Some part of the spare cells can be used to hold firmware to operate the non-volatile memory controller and implement other features. In operation, when a host needs to read data from or write data to the non-volatile memory, it can communicate with the non-volatile memory controller. If the host provides a logical address to which data is to be read/written, the non-volatile memory controller can convert the logical address received from the host to a physical address in the non-volatile memory. (Alternatively, the host can provide the physical address.) The non-volatile memory controller can also perform various memory management functions, such as, but not limited to, wear leveling (distributing writes to avoid wearing out specific blocks of memory that would otherwise be repeatedly written to) and garbage collection (after a block is full, moving only the valid pages of data to a new block, so the full block can be erased and reused).

Non-volatile memory die 104 may include any suitable non-volatile storage medium, including resistive random-access memory (ReRAM), magnetoresistive random-access memory (MRAM), phase-change memory (PCM), NAND flash memory cells and/or NOR flash memory cells. The memory cells can take the form of solid-state (e.g., flash) memory cells and can be one-time programmable, few-time programmable, or many-time programmable. The memory cells can also be single-level cells (SLC), multiple-level cells (MLC), triple-level cells (TLC), or use other memory cell level technologies, now known or later developed. Also, the memory cells can be fabricated in a two-dimensional or three-dimensional fashion.

The interface between controller 102 and non-volatile memory die 104 may be any suitable flash interface, such as Toggle Mode 200, 400, or 800. In one embodiment, the data storage device 100 may be a card based system, such as a secure digital (SD) or a micro secure digital (micro-SD) card. In an alternate embodiment, the data storage device 100 may be part of an embedded data storage device.

Although, in the example illustrated in FIG. 1A, the data storage device 100 (sometimes referred to herein as a storage module) includes a single channel between controller 102 and non-volatile memory die 104, the subject matter described herein is not limited to having a single memory channel. For example, in some architectures (such as the ones shown in FIGS. 1B and 1C), two, four, eight or more memory channels may exist between the controller and the memory device, depending on controller capabilities. In any of the embodiments described herein, more than a single channel may exist between the controller and the memory die, even if a single channel is shown in the drawings.

FIG. 1B illustrates a storage module 200 that includes plural non-volatile data storage devices 100. As such, storage module 200 may include a storage controller 202 that interfaces with a host and with data storage device 204, which includes a plurality of data storage devices 100. The interface between storage controller 202 and data storage devices 100 may be a bus interface, such as a serial advanced technology attachment (SATA), peripheral component interconnect express (PCIe) interface, or double-data-rate (DDR) interface. Storage module 200, in one embodiment, may be a solid state drive (SSD), or non-volatile dual in-line memory module (NVDIMM), such as found in server PC or portable computing devices, such as laptop computers, and tablet computers.

FIG. 1C is a block diagram illustrating a hierarchical storage system. A hierarchical storage system 250 includes a plurality of storage controllers 202, each of which controls a respective data storage device 204. Host systems 252 may access memories within the storage system 250 via a bus interface. In one embodiment, the bus interface may be a Non-Volatile Memory Express (NVMe) or Fibre Channel over Ethernet (FCoE) interface. In one embodiment, the system illustrated in FIG. 1C may be a rack mountable mass storage system that is accessible by multiple host computers, such as would be found in a data center or other location where mass storage is needed.

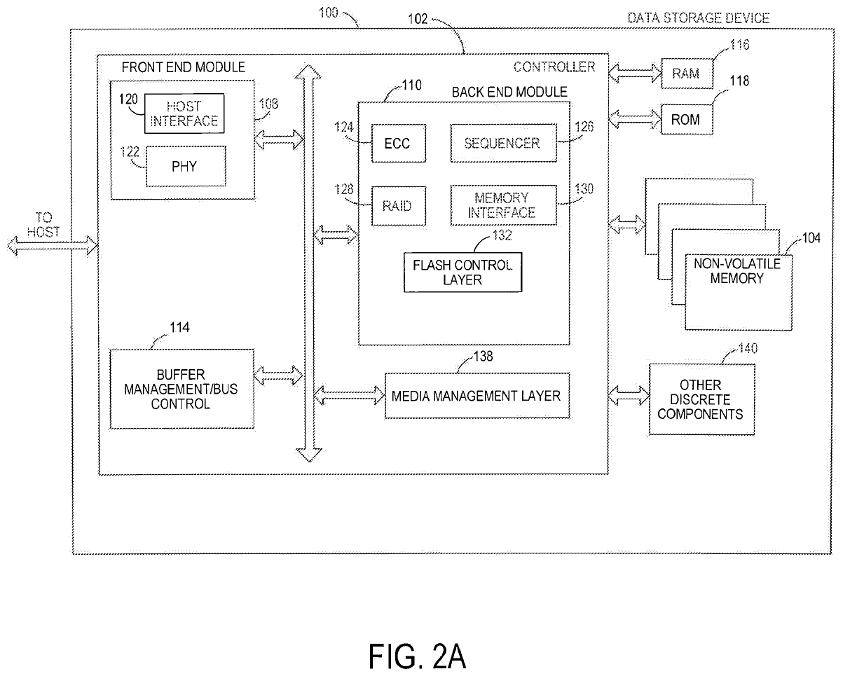

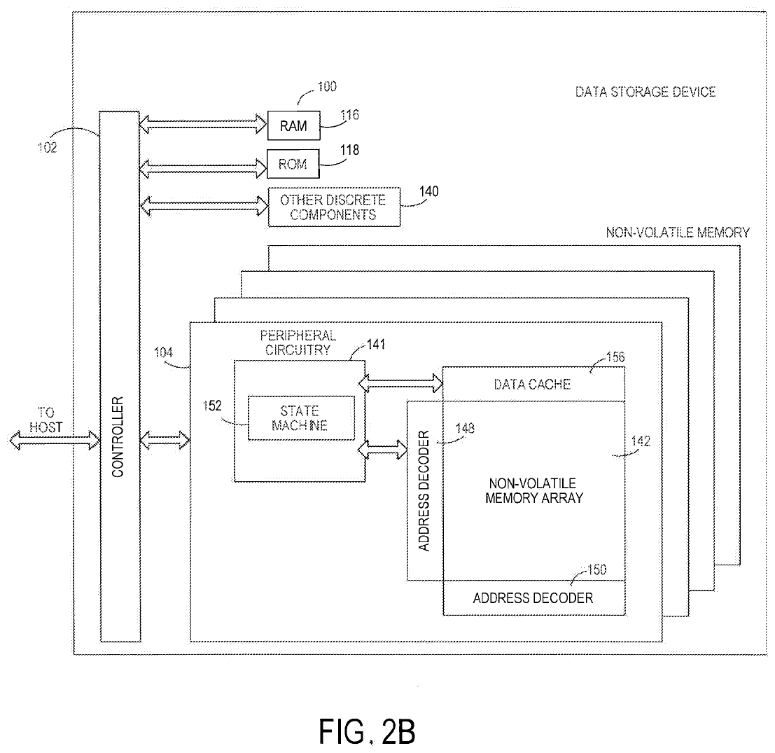

FIG. 2A is a block diagram illustrating components of controller 102 in more detail. Controller 102 includes a front-end module 108 that interfaces with a host, a back-end module 110 that interfaces with the one or more non-volatile memory die 104, and various other modules that perform functions which will now be described in detail. A module may take the form of a packaged functional hardware unit designed for use with other components, a portion of a program code (e.g., software or firmware) executable by a (micro)processor or processing circuitry that usually performs a particular function of related functions, or a self-contained hardware or software component that interfaces with a larger system, for example. Also, “means” for performing a function can be implemented with at least any of the structure noted herein for the controller and can be pure hardware or a combination of hardware and computer-readable program code.

Referring again to modules of the controller 102, a buffer manager/bus controller 114 manages buffers in random access memory (RAM) 116 and controls the internal bus arbitration of controller 102. A read only memory (ROM) 118 stores system boot code. Although illustrated in FIG. 2A as located separately from the controller 102, in other embodiments one or both of the RAM 116 and ROM 118 may be located within the controller. In yet other embodiments, portions of RAM and ROM may be located both within the controller 102 and outside the controller.

Front-end module 108 includes a host interface 120 and a physical layer interface (PHY) 122 that provide the electrical interface with the host or next level storage controller. The choice of the type of host interface 120 can depend on the type of memory being used. Examples of host interfaces 120 include, but are not limited to, SATA, SATA Express, serially attached small computer system interface (SAS), Fibre Channel, universal serial bus (USB), PCIe, and NVMe. The host interface 120 typically facilitates transfer for data, control signals, and timing signals.

Back-end module 110 includes an error correction code (ECC) engine 124 that encodes the data bytes received from the host, and decodes and error corrects the data bytes read from the non-volatile memory. A command sequencer 126 generates command sequences, such as program and erase command sequences, to be transmitted to non-volatile memory die 104. A RAID (Redundant Array of Independent Drives) module 128 manages generation of RAID parity and recovery of failed data. The RAID parity may be used as an additional level of integrity protection for the data being written into the memory device 104. In some cases, the RAID module 128 may be a part of the ECC engine 124. A memory interface 130 provides the command sequences to non-volatile memory die 104 and receives status information from non-volatile memory die 104. In one embodiment, memory interface 130 may be a double data rate (DDR) interface, such as a Toggle Mode 200, 400, or 800 interface. A flash control layer 132 controls the overall operation of back-end module 110.

The data storage device 100 also includes other discrete components 140, such as external electrical interfaces, external RAM, resistors, capacitors, or other components that may interface with controller 102. In alternative embodiments, one or more of the physical layer interface 122, RAID module 128, media management layer 138 and buffer management/bus controller 114 are optional components that are not necessary in the controller 102.

FIG. 2B is a block diagram illustrating components of non-volatile memory die 104 in more detail. Non-volatile memory die 104 includes peripheral circuitry 141 and non-volatile memory array 142. Non-volatile memory array 142 includes the non-volatile memory cells used to store data. The non-volatile memory cells may be any suitable non-volatile memory cells, including ReRAM, MRAM, PCM, NAND flash memory cells and/or NOR flash memory cells in a two-dimensional and/or three-dimensional configuration. Non-volatile memory die 104 further includes a data cache 156 that caches data. Peripheral circuitry 141 includes a state machine 152 that provides status information to the controller 102.

Returning again to FIG. 2A, the flash control layer 132 (which will be referred to herein as the flash translation layer (FTL) or, more generally, the “media management layer,” as the memory may not be flash) handles flash errors and interfaces with the host. In particular, the FTL, which may be an algorithm in firmware, is responsible for the internals of memory management and translates writes from the host into writes to the memory 104. The FTL may be needed because the memory 104 may have limited endurance, may be written in only multiples of pages, and/or may not be written unless it is erased as a block. The FTL understands these potential limitations of the memory 104, which may not be visible to the host. Accordingly, the FTL attempts to translate the writes from host into writes into the memory 104.

The FTL may include a logical-to-physical address (L2P) map and allotted cache memory. In this way, the FTL translates logical block addresses (“LBAs”) from the host to physical addresses in the memory 104. The FTL can include other features, such as, but not limited to, power-off recovery (so that the data structures of the FTL can be recovered in the event of a sudden power loss) and wear leveling (so that the wear across memory blocks is even to prevent certain blocks from excessive wear, which would result in a greater chance of failure).

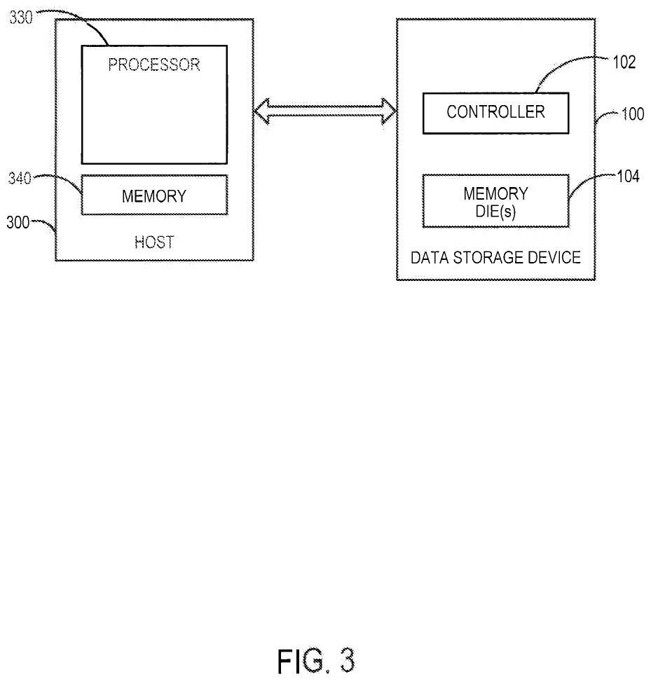

Turning again to the drawings, FIG. 3 is a block diagram of a host 300 and data storage device 100 of an embodiment. The host 300 can take any suitable form, including, but not limited to, a computer, a mobile phone, a tablet, a wearable device, a digital video recorder, a surveillance system, etc. The host 300 in this embodiment (here, a computing device) comprises a processor 330 and a memory 340. In one embodiment, computer-readable program code stored in the host memory 340 configures the host processor 330 to perform the acts described herein. So, actions performed by the host 300 are sometimes referred to herein as being performed by an application (computer-readable program code) run on the host 300.

As mentioned above, a host can store data in a data storage device and later retrieve the data. In some situations, after the host retrieves the data from the data storage device, the host performs a data transformation operation on the data. As used herein, a data transformation operation is an operation that transforms data in some fashion. A data transformation operation can take any suitable form. Examples of data transformation operation include, but are not limited to, an operation that transforms the data between time and frequency domains. an operation that transforms the data between fixed-point and floating-point formats, a data approximation operation, an image analysis operation, a data filtering operation, a data reformatting operation, an operation that pre-processes the data for a machine learning algorithm, a convolution operation, and a lossless data transformation operation.

Some data storage devices have a compute-in-place feature that allows the host to offload the data transformation operation to the data storage device. In such environments, the host can send a read request to the data storage device that instructs the data storage device to read the data, perform a data transformation operation on the read data, and then return the result. Because such data transformation operations are triggered on a read command, there may be a delay in returning the results of the operations. Accordingly, this approach may have a latency overhead attached to it, which may be undesirable. The following embodiments can be used to address this issue and optimize latency.

In general, in the following embodiments, instead of performing the data transformation operation as part of executing a read command where latencies would be noticeable, the data transformation operation can be performed as part of executing a write command, where latencies would be less noticeable. The data storage device 100 can be instructed by the host 300 to perform the data transformation operation during a write operation, or the data storage device 100 can make the determination on its own that the data transformation operation should be performed (e.g., using machine learning/predictions).

The read command from the host 300 is like a compute request to the data storage device 100. That is, instead of the read command, the host 300 can issue a compute command on some data. In these embodiments, this can be pre-transformed, hence resulting in less latency. On similar lines, in the host-assisted approach, instead of a compute tag in the write command, the instruction can be separately sent (e.g., through a vendor-specific command) for pre-transformation (e.g., after data writes but before read/compute).

For example, in one embodiment, the host 300 sends the data storage device 100 a write command to write data in the memory 104. The write command comprises an instruction (e.g., a tag with the data transformation type required by the host 300) to perform a data transformation operation on the data. In response to this command, the controller 102 executes the write command by performing the data transformation operation on the data to generate transformed data and writing the transformed data in the memory 104. As part of performing the data transformation operation, the controller 102 can access, from the memory 104, information needed to perform the data transformation operation. For example, if the data transformation operation includes data pre-processing techniques required for a machine-learning algorithm, these transformations can enable conversion of the raw data into a clean data set. As another example, in a signal processing use case, samples that are stored as a primary copy are Fourier transformed, and the results of the transformation are stored as a secondary copy. The primary copy can be in the time domain, whereas the secondary copy can be in the frequency domain. If both copies are stored, the host 300 can access the stored data in any format.

As noted above, the data that was sent as part of the write command can also be written in the memory 104 (e.g., both the data and the transformed data can be written to the memory 104 as part of executing the write command), or just the transformed data can be written. If both the data and the transformed data are written to the memory 104, they can be written to different logical regions of the memory 104 (e.g., to different logical unit numbers (LUNs) or namespaces). Those different logical regions of the memory 104 can both be accessible by the host 300.

When the host 300 later sends a read command to the data storage device 100, the controller 102 of the data storage device 100 can determine whether the read command is requesting the data or the transformed data. If the host 300 is requesting the data, the controller 102 reads the data from the memory 104 and returns it to the host 300. However, if the host is requesting the transformed data, the controller 102 reads the transformed data from the memory 104 and returns it to the host 300. Because the data is already transformed, the controller 102 simply returns it to the host 300, avoiding the latency that would otherwise have been incurred if the controller 102 needed to perform the data transformation operation as part of executing the read command.

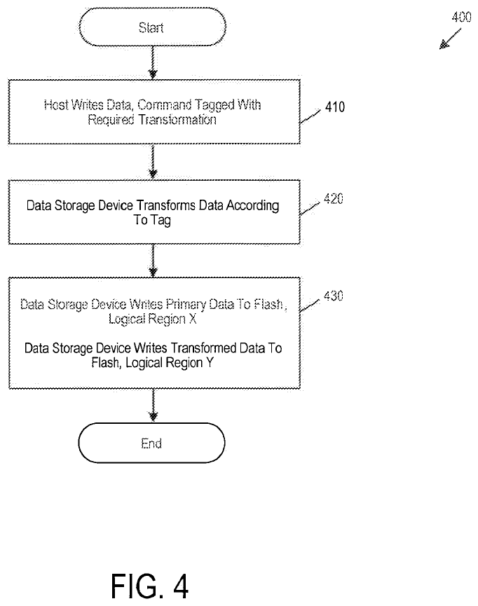

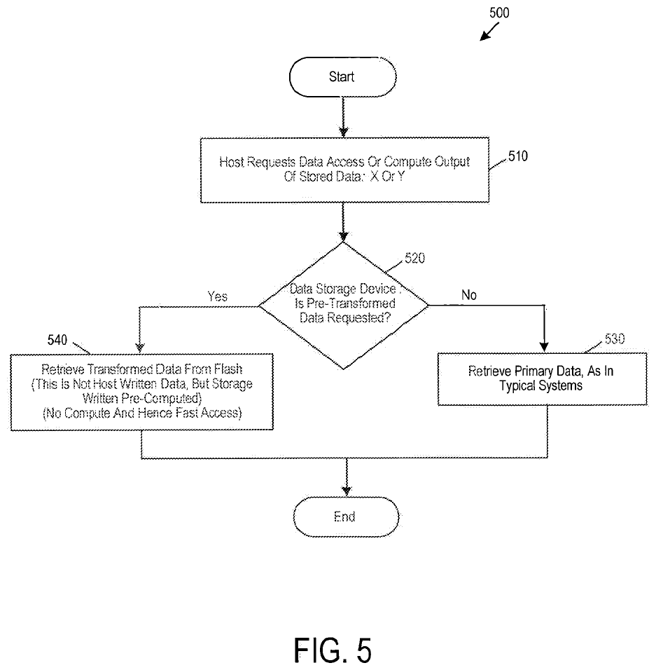

Turning again to the drawings, FIGS. 4 and 5 illustrate one example implementation of these embodiments. FIG. 4 is a flow chart 400 of a method of an embodiment for host-assisted pre-transformation performed in a write path. As shown in FIG. 4, the host 300 sends to the data storage device 100 data and a write command that is tagged with the required data transformation operation (act 410). In response, the data storage device 100 transforms the data according to the tag (act 420). The data storage device 100 writes the primary data to the memory 104 in logical region X and also writes the transformed data to the memory 104 in logical region Y (acts 430). The secondary copy can be just another logical data set (i.e., the host 300 writes X, and the data storage device 100 stores it and the transformation result as X and Y).

FIG. 5 is a flow chart 500 of a method of an embodiment for host-assisted pre-transformation performed in a read path. As shown in FIG. 5, the host 300 requests data access of a transformed output of stored data in logical region X or Y (act 510). This method illustrates that, in host-assisted systems, since the transformations are transparent to the host 300, the transformed copy can stay in a different logical region under the preview of the host 300. Next, the data storage device 100 determines if pre-transformed data is being requested (act 520). If pre-transformed data is being not requested, the data storage device 100 retrieves the regular data (act 530). However, if pre-transformed data is being requested, the data storage device 100 retrieves the pre-transformed data (act 540). Because the data is already transformed at this point, the data storage device 100 simply returns the retrieved data to the host 300 and does not need to perform the data transformation step, thereby providing faster access time than when such as step is performed during the read process.

In another embodiment, instead of the host 300 instructing the data storage device 100 to perform the data transformation operation, the data storage device 100 makes that determination on its own. For example, the data storage device 100 can perform learning and identify the type of transformation needed and the related data region, which potentially can need transformation. On determining the type and the region of transformed data based on its learning, the data storage device 100 can subsequently transform and store the transformed data in a secondary storage or a device-specific memory region abstracted from the host 300, such as a separate logical unit number (LUN)/namespace. On a host request for computation, the pre-transformed data can be provided right away, thereby saving compute time required for transformation. That is, transforming a data post-host-request can have latency since the transformation may have dependency on other data stored in other parts of the memory 104. Hence, the proposed methods may be handy to optimize such latencies.

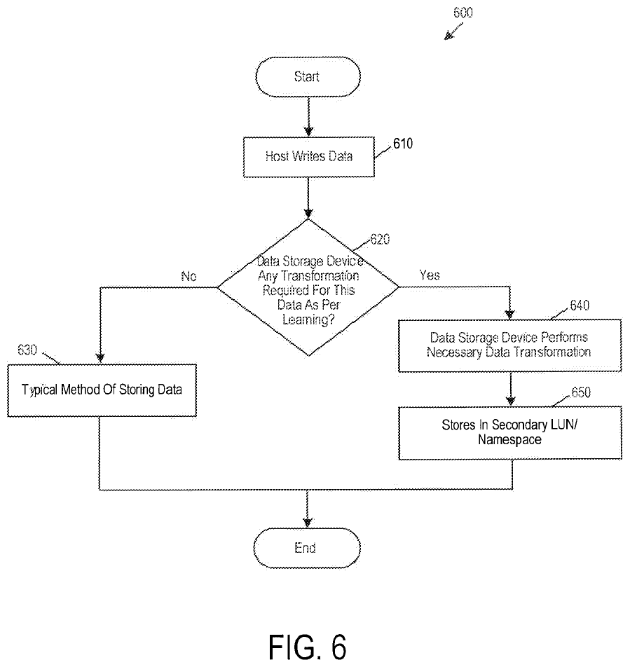

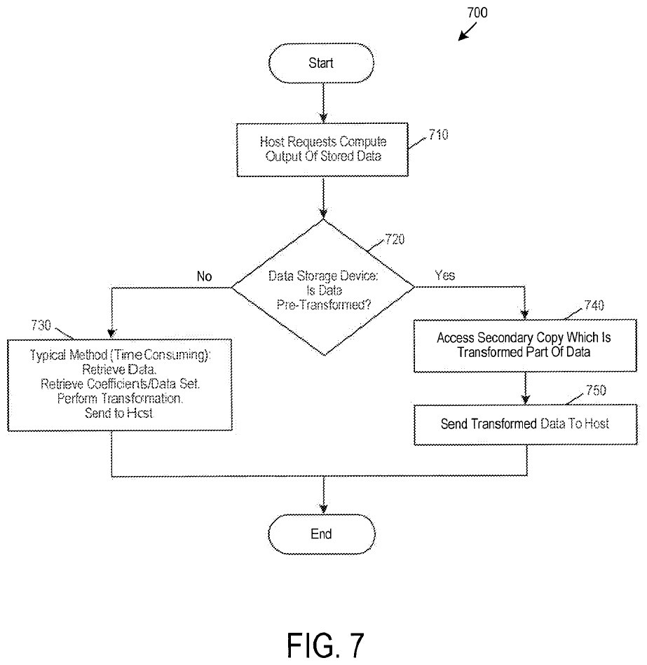

Returning to the drawings, FIGS. 6 and 7 illustrate one example implementation of this embodiment. FIG. 6 is a flow chart of a method of an embodiment for data-storage-device-assisted pre-transformation performed in a write path. As shown in FIG. 6, after the host 300 writes data (act 610), the data storage device 100 determines if any transformation of the data is required (act 620). If no data transformation is required, the data is simply stored in the memory 104 (act 630). However, if data transformation is required, the data storage device 100 performs the necessary data transformation (act 640), and the results are stored in the memory 104 (e.g., in a secondary logical unit number (LUN) or namespace) (act 650). So, in this example of a device-specific system, the transformed copy can be stored in a second read-only LUN/namespace, under the control of the data storage device 100, abstracted from host 300, alongside the primary data writes.

So, as shown in this example, as part of executing a write command from the host 300 to write data, the controller 102 in the data storage device 100 can determine whether a data transformation operation should be performed on the data prior to writing the data in the memory 104. This determination can be made, for example, using machine learning. If no data transformation operation is to be performed, the data is just stored in the memory 104. However, if a data transformation operation is to be performed, the controller 102 performs the data transformation operation on the data to generate transformed data and writes the transformed data in the memory 104. The controller 102 can also write the data sent by the host 300 to the memory 104 (e.g., as part of executing the write command, or afterwards). In that case, the transformed data and the data can be written in different logical unit numbers or namespaces that are both accessible by the host 300.

FIG. 7 is a flow chart 700 of a method of an embodiment for data-storage-device-assisted pre-transformation performed in a read path. As shown in FIG. 7, after the host 300 requests compute of stored data (act 710), the data storage device 100 determines if the data is pre-transformed (act 720). If the data is not pre-transformed, the data storage device 100 retrieves coefficients and the data set, performs the transformation, and returns the result to the host 300. However, if the data is pre-transformed, the data storage device 100 accesses the secondary copy, which is the transformed part of the data (act 740), and sends the transformed data to the host 300 (act 750).

So, as shown in this example, when the host 300 later sends a command to the data storage device 100 to perform a data transformation operation on first data that the host 300 previously sent to the data storage device 100 for storage, the controller 102 can determine whether the data storage device 100 already performed the data transformation operation on the first data. In response to determining that the data storage device 100 already performed the data transformation operation on the first data, a result of the already-performed data transformation operation on the first data can be returned to the host 300. In response to determining that the data storage device 100 did not already perform the data transformation operation on the first data, the controller 102 can perform the data transformation operation on the first data and return a result of the data transformation operation on the first data to the host 300.

As shown by the above, both the host-centric and the data-storage-device-centric methods provide good returns for data associated with a write-once-read-many requirement since the data is transformed only once during storage write. In one embodiment, the data storage device 100 just retrieves pre-transformed data from the memory 104 on compute request, contrary to a typical data storage device that can potentially transform the stored data on every data retrieval operation.

There embodiments can be used in any suitable application. For example, standard data operations related to machine learning and legacy applications, such as image analysis, data filtering, and data reformatting, may be common use cases for these embodiments, where some form of data transformation is needed based on the stored data. Accessing relevant coefficients/sample sets from the memory 104, transforming incoming data, and maintaining a copy saves considerable compute access time during retrieval.

Also, the data storage device 100 of these embodiments can be designed to be a fixed-purpose computational storage device that only knows how to do one (or some other limited number) of data transformation operations and performs that operation when instructed to by the host 300 and/or when it detects that the operation is needed. While these embodiments can be used in any suitable application, these embodiments may be particularly desired in Internet of Things and embedded applications (where the data storage device 100 is embedded in the host 300), as those applications typically do not need (and cannot afford) full-scale computational storage.

There are many alternatives that can be used with these embodiments. For example, as discussed above, in one alternative embodiment, only the transformed data is stored, and the primary data is skipped from storage. This may be the case, for example, when sensors generate raw audio data in the time domain, and a set of analyzers (offline or online) analyzes the Power Spectral Density (PSD) of the data. To determine the PSD, the data storage device 100 can transform the data, and the analyzer may never need the actual data itself if the PSD is readily available.

In another alternative, input data is convoluted with filter coefficients in the data storage device 100, and the convoluted data is stored as a secondary copy in the memory 100, with the primary copy being the input itself. In yet another alternative, the data storage device 100 can perform lossless transformation of data. On determining that the primary data has an uncorrectable error correction code (UECC) failure, the data storage device can perform inverse transformation of the secondary data to get the primary data (e.g., lossless Fourier transformed data).

Finally, as mentioned above, any suitable type of memory can be used. Semiconductor memory devices include volatile memory devices, such as dynamic random access memory (“DRAM”) or static random access memory (“SRAM”) devices, non-volatile memory devices, such as resistive random access memory (“ReRAM”), electrically erasable programmable read only memory (“EEPROM”), flash memory (which can also be considered a subset of EEPROM), ferroelectric random access memory (“FRAM”), and magnetoresistive random access memory (“MRAM”), and other semiconductor elements capable of storing information. Each type of memory device may have different configurations. For example, flash memory devices may be configured in a NAND or a NOR configuration.

The memory devices can be formed from passive and/or active elements, in any combinations. By way of non-limiting example, passive semiconductor memory elements include ReRAM device elements, which in some embodiments include a resistivity switching storage element, such as an anti-fuse, phase change material, etc., and optionally a steering element, such as a diode, etc. Further by way of non-limiting example, active semiconductor memory elements include EEPROM and flash memory device elements, which in some embodiments include elements containing a charge storage region, such as a floating gate, conductive nanoparticles, or a charge storage dielectric material.

Multiple memory elements may be configured so that they are connected in series or so that each element is individually accessible. By way of non-limiting example, flash memory devices in a NAND configuration (NAND memory) typically contain memory elements connected in series. A NAND memory array may be configured so that the array is composed of multiple strings of memory in which a string is composed of multiple memory elements sharing a single bit line and accessed as a group. Alternatively, memory elements may be configured so that each element is individually accessible, e.g., a NOR memory array. NAND and NOR memory configurations are examples, and memory elements may be otherwise configured.

The semiconductor memory elements located within and/or over a substrate may be arranged in two or three dimensions, such as a two-dimensional memory structure or a three-dimensional memory structure.

In a two-dimensional memory structure, the semiconductor memory elements are arranged in a single plane or a single memory device level. Typically, in a two-dimensional memory structure, memory elements are arranged in a plane (e.g., in an x-z direction plane) which extends substantially parallel to a major surface of a substrate that supports the memory elements. The substrate may be a wafer over or in which the layer of the memory elements are formed or it may be a carrier substrate which is attached to the memory elements after they are formed. As a non-limiting example, the substrate may include a semiconductor such as silicon.

The memory elements may be arranged in the single memory device level in an ordered array, such as in a plurality of rows and/or columns. However, the memory elements may be arrayed in non-regular or non-orthogonal configurations. The memory elements may each have two or more electrodes or contact lines, such as bit lines and wordlines.

A three-dimensional memory array is arranged so that memory elements occupy multiple planes or multiple memory device levels, thereby forming a structure in three dimensions (i.e., in the x, y and z directions, where the y direction is substantially perpendicular and the x and z directions are substantially parallel to the major surface of the substrate).

As a non-limiting example, a three-dimensional memory structure may be vertically arranged as a stack of multiple two-dimensional memory device levels. As another non-limiting example, a three-dimensional memory array may be arranged as multiple vertical columns (e.g., columns extending substantially perpendicular to the major surface of the substrate, i.e., in the y direction) with each column having multiple memory elements in each column. The columns may be arranged in a two-dimensional configuration, e.g., in an x-z plane, resulting in a three-dimensional arrangement of memory elements with elements on multiple vertically stacked memory planes. Other configurations of memory elements in three dimensions can also constitute a three-dimensional memory array.

By way of non-limiting example, in a three-dimensional NAND memory array, the memory elements may be coupled together to form a NAND string within a single horizontal (e.g., x-z) memory device levels. Alternatively, the memory elements may be coupled together to form a vertical NAND string that traverses across multiple horizontal memory device levels. Other three-dimensional configurations can be envisioned wherein some NAND strings contain memory elements in a single memory level while other strings contain memory elements which span through multiple memory levels. Three-dimensional memory arrays may also be designed in a NOR configuration and in a ReRAM configuration.

Typically, in a monolithic three-dimensional memory array, one or more memory device levels are formed above a single substrate. Optionally, the monolithic three-dimensional memory array may also have one or more memory layers at least partially within the single substrate. As a non-limiting example, the substrate may include a semiconductor such as silicon. In a monolithic three-dimensional array, the layers constituting each memory device level of the array are typically formed on the layers of the underlying memory device levels of the array. However, layers of adjacent memory device levels of a monolithic three-dimensional memory array may be shared or have intervening layers between memory device levels.

Then again, two-dimensional arrays may be formed separately and then packaged together to form a non-monolithic memory device having multiple layers of memory. For example, non-monolithic stacked memories can be constructed by forming memory levels on separate substrates and then stacking the memory levels atop each other. The substrates may be thinned or removed from the memory device levels before stacking, but as the memory device levels are initially formed over separate substrates, the resulting memory arrays are not monolithic three-dimensional memory arrays. Further, multiple two-dimensional memory arrays or three-dimensional memory arrays (monolithic or non-monolithic) may be formed on separate chips and then packaged together to form a stacked-chip memory device.

Associated circuitry is typically required for operation of the memory elements and for communication with the memory elements. As non-limiting examples, memory devices may have circuitry used for controlling and driving memory elements to accomplish functions such as programming and reading. This associated circuitry may be on the same substrate as the memory elements and/or on a separate substrate. For example, a controller for memory read-write operations may be located on a separate controller chip and/or on the same substrate as the memory elements.

One of skill in the art will recognize that this invention is not limited to the two-dimensional and three-dimensional structures described but cover all relevant memory structures within the spirit and scope of the invention as described herein and as understood by one of skill in the art.

It is intended that the foregoing detailed description be understood as an illustration of selected forms that the invention can take and not as a definition of the invention. It is only the following claims, including all equivalents, that are intended to define the scope of the claimed invention. Finally, it should be noted that any aspect of any of the embodiments described herein can be used alone or in combination with one another.

1. A data storage device comprising:
a memory; and
a controller configured to:
receive a write command from a host to write data in the memory, wherein the write command comprises an indication of a data transformation operation to be performed on the data;
execute the write command by:
performing the data transformation operation on the data to generate transformed data, wherein the data transformation operation is performed prior to receiving a read command from the host for the transformed data; and
writing the transformed data in the memory;
receive the read command from the host for the transformed data; and
execute the read command by returning the transformed data to the host, wherein performing the data transformation operation prior to receiving the read command reduces read latency.

2. The data storage device of claim 1, wherein the controller is further configured to write the data in the memory.

3. The data storage device of claim 2, wherein the data and the transformed data are written to different logical regions of the memory.

4. The data storage device of claim 3, wherein the different logical regions are both accessible by the host.

5. The data storage device of claim 2, wherein the data and the transformed data are both written to the memory as part of executing the write command.

6. The data storage device of claim 2, wherein the controller is further configured to:
receive a read command from the host requesting the data; and
return the data to the host.

7. The data storage device of claim 1, wherein the controller is further configured to access, from the memory, information needed to perform the data transformation operation.

8. The data storage device of claim 1, wherein the data transformation operation comprises one or more of the following: an operation that transforms the data between time and frequency domains, an operation that transforms the data between fixed-point and floating-point formats, a data approximation operation, an image analysis operation, a data filtering operation, a data reformatting operation, an operation that pre-processes the data for a machine learning algorithm, a convolution operation, and a lossless data transformation operation.

9. The data storage device of claim 1, wherein the memory comprises a three-dimensional memory.

10. A method comprising:
performing the following in a data storage device comprising a memory:
receiving a write command from a host to write data in the memory, wherein the write command comprises a tag representing a data transformation operation to be performed on the data;
executing the write command by:
performing the data transformation operation on the data to generate transformed data, wherein the data transformation operation is performed prior to receiving a read command from the host for the transformed data; and
writing the transformed data in the memory;
receiving the read command from the host for the transformed data; and
executing the read command by returning the transformed data to the host, wherein performing the data transformation operation prior to receiving the read command reduces read latency.

11. (canceled)

12. The method of claim 10, further comprising writing the data to the memory.

13. The method of claim 12, wherein the data and the transformed data are both written to the memory as part of executing the write command.

14. The method of claim 12, wherein the transformed data and the data are written in different logical unit numbers or namespaces.

15. The method of claim 14, wherein the different logical unit numbers are both accessible by the host.

16. The method of claim 10, further comprising:
receiving a command from the host to perform a data transformation operation on first data that the host previously sent to the data storage device for storage;
determining whether the data storage device already perform the data transformation operation on the first data; and
in response to determining that the data storage device already performed the data transformation operation on the first data, returning a result of the already-performed data transformation operation on the first data to the host.

17. The method of claim 16, further comprising:
in response to determining that the data storage device did not already perform the data transformation operation on the first data, performing the data transformation operation on the first data and returning a result of the data transformation operation on the first data to the host.

18. The method of claim 10, further comprising accessing, from the memory, information needed to perform the data transformation operation.

19. The method of claim 10, wherein the data transformation operation comprises one or more of the following: an operation that transforms the data between time and frequency domains, an operation that transforms the data between fixed-point and floating-point formats, a data approximation operation, an image analysis operation, a data filtering operation, a data reformatting operation, an operation that pre-processes the data for a machine learning algorithm, a convolution operation, and a lossless data transformation operation.

20. A data storage device comprising:
a memory;
means for receiving a write command from a host to write data in the memory, wherein the write command comprises a request to perform a data transformation operation on the data;
means for executing the write command by:
performing the data transformation operation on the data to generate transformed data, wherein the data transformation operation is performed prior to receiving a read command from the host for the transformed data; and
writing the transformed data in the memory;
means for receiving the read command from the host for the transformed data; and
means for executing the read command by returning the transformed data to the host, wherein performing the data transformation operation prior to receiving the read command reduces read latency.

21. The method of claim 14, wherein the namespaces are both accessible by the host.
